(19) United States
(12) Patent Application Publication
(10) Pub. No.: US 2025/0185001 A1
(43) Pub. Date: Jun. 5, 2025

(54) CONTROL INFORMATION PRIORITIZATION TECHNIQUES FOR MULTIPLE LOGICAL CHANNELS

(71) Applicant: QUALCOMM Incorporated, San Diego, CA (US)

(72) Inventors: Vaishakh RAO, San Diego, CA (US); Ajeet KUMAR, HYDERABAD (IN); Sathish Kumar NALLAMANTI, Hyderabad (IN); Krishna Chaitanya BELLAM, Hyderabad (IN); Yuyi LI, Shanghai (CN); Vishal DALMIYA, San Diego, CA (US); Nan ZHANG, Beijing (CN); Ankita MAAN, Hyderabad (IN); Ashwin MADHUR COMANDUR, San Diego, CA (US); Naga Yaswanth KOTHA, Thotlavalluru (IN); Pankaj MITTAL, Hyderabad (IN)

(21) Appl. No.: 18/842,741

(22) PCT Filed: Apr. 30, 2022
(86) PCT No.: PCT/CN2022/090830

§ 371 Date: Aug. 29, 2024

(51) Int. Cl. H04W 72/1268; H04W 72/0453; H04W 72/20; H04W 72/563

(52) U.S. Cl. CPC H04W 72/1268; H04W 72/0453; H04W 72/20; H04W 72/563

(57) ABSTRACT

Methods, systems, and devices for wireless communications are described that provide techniques for resource distribution at a user equipment (UE) in which control data of lower priority logical channels may be transmitted to avoid a window stall and connection release of such lower priority logical channels. A resource distribution scheme at a UE may be adjusted to change a prioritized bit rate (PBR) of one or more logical channels to correspond only to the amount of high priority information that is present for each logical channel. Then, after resources are distributed to cach logical channel for the high priority information, the PBRs for each logical channel are reset to the original values and remaining uplink resources are distributed in accordance with the logical channel priority and associated PBRs.

### CROSS REFERENCE

The present Application is a 371 national stage filing of International PCT Application No. PCT/CN2022/090830 by RAO et al. entitled “CONTROL INFORMATION PRIORITIZATION TECHNIQUES FOR MULTIPLE LOGICAL CHANNELS,” filed Apr. 30, 2022, which is assigned to the assignee hereof, and which is expressly incorporated by reference in its entirety herein.

### INTRODUCTION

The following relates to wireless communications, including control information prioritization techniques for multiple logical channels.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communication at a user equipment (UE) is described. The method may include receiving an uplink grant that indicates a resource allocation for an uplink communication from the UE to a network entity, the resource allocation for distribution among at least two logical channels including a first logical channel that has a higher priority than a second logical channel, where a distribution scheme provides a first amount of the resource allocation to the first logical channel and the first amount exceeds a threshold value, adjusting the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel, and transmitting one or more transport blocks that include the first amount of control information for the first logical channel and the second amount of control information for the second logical channel.

An apparatus for wireless communication at a UE is described. The apparatus may include a processor, memory coupled with the processor, and instructions stored in the memory. The instructions may be executable by the processor to cause the apparatus to receive an uplink grant that indicates a resource allocation for an uplink communication from the UE to a network entity, the resource allocation for distribution among at least two logical channels including a first logical channel that has a higher priority than a second logical channel, where a distribution scheme provides a first amount of the resource allocation to the first logical channel and the first amount exceeds a threshold value, adjust the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel, and transmit one or more transport blocks that include the first amount of control information for the first logical channel and the second amount of control information for the second logical channel.

Another apparatus for wireless communication at a UE is described. The apparatus may include means for receiving an uplink grant that indicates a resource allocation for an uplink communication from the UE to a network entity, the resource allocation for distribution among at least two logical channels including a first logical channel that has a higher priority than a second logical channel, where a distribution scheme provides a first amount of the resource allocation to the first logical channel and the first amount exceeds a threshold value, means for adjusting the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel, and means for transmitting one or more transport blocks that include the first amount of control information for the first logical channel and the second amount of control information for the second logical channel.

A non-transitory computer-readable medium storing code for wireless communication at a UE is described. The code may include instructions executable by a processor to receive an uplink grant that indicates a resource allocation for an uplink communication from the UE to a network entity, the resource allocation for distribution among at least two logical channels including a first logical channel that has a higher priority than a second logical channel, where a distribution scheme provides a first amount of the resource allocation to the first logical channel and the first amount exceeds a threshold value, adjust the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel, and transmit one or more transport blocks that include the first amount of control information for the first logical channel and the second amount of control information for the second logical channel.

Some examples of the method, apparatuses, and non-transitory computer-readable medium described herein may further include operations, features, means, or instructions for re-adjusting the distribution scheme to provide a remaining portion of the first amount of the resource allocation to the first logical channel and where the one or more transport blocks include additional uplink data for at least the first logical channel based on the remaining portion of the first amount of the resource allocation. In some examples of the method, apparatuses, and non-transitory computer-readable medium described herein, the adjusting may include operations, features, means, or instructions for updating a first prioritized bit rate (PBR) of the first logical channel to correspond to the first amount of control information and updating a second PBR of the second logical channel to correspond to the second amount of control information. In some examples of the method, apparatuses, and non-transitory computer-readable medium described herein, the first amount of control information and the second amount of control information occupy a first subset of the resource allocation and the method, apparatuses, and non-transitory computer-readable medium may include further operations, features, means, or instructions for distributing a second subset of the resource allocation among the at least two logical channels based on an original prioritized bit rate associated with each logical channel of the at least two logical channels.

In some examples of the method, apparatuses, and non-transitory computer-readable medium described herein, the adjusting may include operations, features, means, or instructions for adjusting, for each logical channel of the at least two logical channels, a prioritized bit rate (PBR) to correspond to a minimum of a current PBR or a corresponding amount of control information that may be to be transmitted on the associated logical channel. In some examples of the method, apparatuses, and non-transitory computer-readable medium described herein, the first amount of control information corresponds to a first number of bytes in a first high priority traffic protocol data unit (PDU) of the first logical channel, and the second amount of control information corresponds to a second number of bytes in a second high priority traffic PDU of the second logical channel. In some examples of the method, apparatuses, and non-transitory computer-readable medium described herein, a highest priority logical channel of the two or more logical channels may be provided with any remaining resources of the resource allocation prior to distributing any resources of the resource allocation to any lower priority logical channels.

Some examples of the method, apparatuses, and non-transitory computer-readable medium described herein may further include operations, features, means, or instructions for forming the one or more transport blocks in accordance with the distribution scheme for transmission to the network entity. In some examples of the method, apparatuses, and non-transitory computer-readable medium described herein, the adjusting may be performed based on whether the second logical channel may have a radio link control (RLC) control protocol data unit (PDU) or high priority data in an associated transmit buffer. In some examples of the method, apparatuses, and non-transitory computer-readable medium described herein, the adjusting may be performed based on whether the first logical channel may have a prioritized bit rate (PBR) that may be set to infinity. In some examples of the method, apparatuses, and non-transitory computer-readable medium described herein, the adjustment to the distribution scheme prevents a bearer release of the second logical channel by providing resources for at least the second amount of control information for the second logical channel.

### BRIEF DESCRIPTION OF THE DRAWINGS

FIGS. 1 and 2 illustrate examples of wireless communications systems that supports control information prioritization techniques for multiple logical channels in accordance with aspects of the present disclosure.

FIG. 3 illustrates an example of a flowchart that illustrates a method for control information prioritization for multiple logical channels in accordance with aspects of the present disclosure.

FIG. 4 illustrates an example of a process flow that supports control information prioritization techniques for multiple logical channels in accordance with aspects of the present disclosure.

FIGS. 5 and 6 show block diagrams of devices that support control information prioritization techniques for multiple logical channels in accordance with aspects of the present disclosure.

FIG. 7 shows a block diagram of a communications manager that supports control information prioritization techniques for multiple logical channels in accordance with aspects of the present disclosure.

FIG. 8 shows a diagram of a system including a device that supports control information prioritization techniques for multiple logical channels in accordance with aspects of the present disclosure.

FIGS. 9 and 10 show flowcharts illustrating methods that support control information prioritization techniques for multiple logical channels in accordance with aspects of the present disclosure.

### DETAILED DESCRIPTION

A wireless communications system may include wireless communications devices, such as a user equipment (UE) and a network entity (e.g., an eNodeB (eNB), a next-generation NodeB or a giga-NodeB, either of which may be referred to as a gNB, a transmission-reception point, or base station), that support wireless communications of data and control information. In some cases, communications between a UE and a network entity may use multiple logical channels, which may define the data-transfer services offered by a medium access control (MAC) layer. For example, data and signaling messages (e.g., control information messages) may be carried on logical channels between a radio link control (RLC) layer and MAC layer of a multi-layer protocol stack, and logical channels may be divided into control channels and traffic channels.

In cases where multiple logical channels are configured (e.g., a UE has multiple logical channel identifications (LCIDs)), a network entity may configure each LCID with a prioritized bit rate (PBR). The PBR may indicate a number of bits of data for the associated LCID that are to be distributed in a resource allocation before moving on to a next LCID, where multiple LCIDs may be ordered based on an associated priority. If resources from an uplink allocation still remain after allocations for each LCID, the UE will repeat the process until either the uplink resource allocation is completely consumed or none of the LCIDs have any more data in their associated buffers. For example, a high priority LCID may a relatively large amount of data in a buffer, and may have a PBR set to infinity, which can result in lower priority LCIDs not getting any resources from an uplink resource grant. In some cases, a logical channel may have an associated window, and in the event that any transport blocks (TBs) are not transmitted on the logical channel during such an associated window, the logical channel may have a window stall that results in a release of the logical channel connection by the network entity. Thus, in the event that a higher priority LCID consumes all of the resource allocations for multiple uplink grants, one or more lower priority LCIDs may be released, and the UE will reestablish the channels in order to transmit any subsequent data. Such situations may cause inefficiencies and increases in overhead and latency associated with release and reestablishment of logical channels.

Various aspects of the present disclosure provide techniques for adjustment of a resource distribution scheme at a UE to provide that control data of lower priority LCIDs may be transmitted to avoid a window stall and connection release of a logical channel. In some cases, a distribution scheme at a UE may be adjusted to change a PBR of each LCID to correspond only to the amount of high priority information (e.g., control information) that is present for each LCID. Then, after resources are distributed to each LCID for the high priority information, the PBRs for each LCID are reset to the original values and remaining uplink resources are distributed in accordance with the LCID priority and associated PBRs. Such techniques may provide that higher priority data of each LCID (e.g., RLC control protocol data unit (PDU) transmissions or other high priority information) is transmitted in order to avoid a window stall, as the network entity identifies that a RLC transmission window is moving and hence the connection associated with the LCID is maintained.

The subject matter described in the present disclosure may be implemented such that a wireless communications system may realize efficient communications, reduced power consumption, lower latency, and the like. For example, configuring the communication devices to support adjustment of resource distribution techniques to provide lower priority logical channels with sufficient resources to prevent a window stall as described herein may result in decreased system latency, and reduced overhead associated with fewer releases of logical channels, and corresponding reductions in power usage.

Aspects of the disclosure are initially described in the context of wireless communications systems. Examples of processes and signaling exchanges that support control information prioritization are then described. Aspects of the disclosure are further illustrated by and described with reference to apparatus diagrams, system diagrams, and flowcharts that relate to control information prioritization techniques for multiple logical channels.

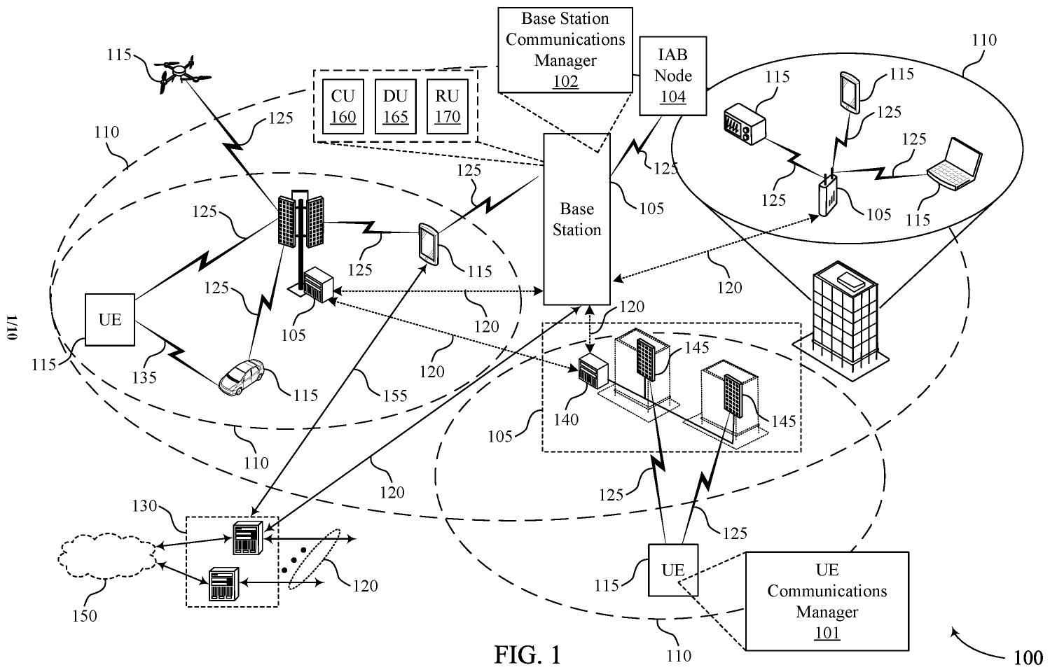

FIG. 1 illustrates an example of a wireless communications system 100 that supports control information prioritization techniques for multiple logical channels in accordance with aspects of the present disclosure. The wireless communications system 100 may include one or more base stations 105 (which may be examples of access network entities), one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, IAB nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. A UE 115 may communicate with the core network 130 through a communication link 155.

One or more of the base stations 105 described herein may include or may be referred to by a person having ordinary skill in the art as a base transceiver station, a radio base station, an access point, a network entity, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz (MHz) to 300 gigahertz (GHz). The region from 300 MHz to 3 GHz is often known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Techniques described herein, in addition to or as an alternative to be carried out between UEs 115 and base stations 105, may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 175 is flexible and as such gives rise to numerous permutations of different functionalities depending upon which functions (e.g., MAC functions, baseband functions, radio frequency functions, and any combinations thereof) are performed at the CU 160, DU 165, and RU 175. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more base stations 105 may include CUs 160, DUs 165, and RUs 170 and may be referred to as donor base stations 105 or IAB donors. One or more DUs 165 (e.g., and/or RUs 170) associated with a donor base station 105 may be partially controlled by CUs 160 associated with the donor base station 105. The one or more donor base stations 105 (e.g., IAB donors) may be in communication with one or more additional base stations 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of base stations 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more network entities such as one or more IAB nodes 104 or components of IAB nodes 104) may be configured to support techniques for resource allocation distribution for multiple logical channels as described herein. For example, some operations described as being performed by a UE 115 or a base station 105 may additionally or alternatively be performed by components of the disaggregated RAN architecture (e.g., IAB nodes, DUs, CUs, other network entities, etc.).

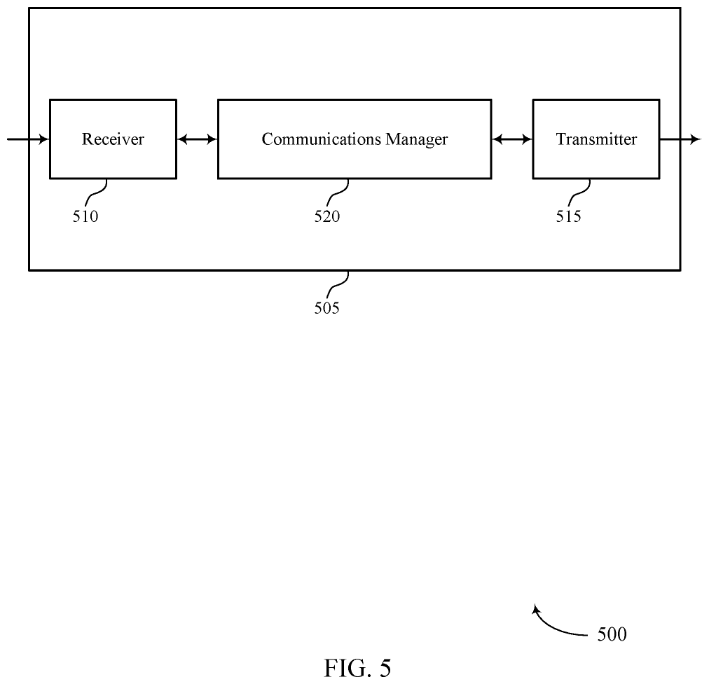

In the wireless communications system 100 a UE 115 and a base station 105 (e.g., an eNodeB (eNB), a next-generation NodeB or a giga-NodeB, either of which may be referred to as a gNB, or some other base station), may support wireless communications over one or multiple radio access technologies. Examples of radio access technologies include 4G systems, such as LTE systems, and 5G systems, which may be referred to as NR systems. The wireless communications system 100 may be configured to support techniques for resource allocation distribution for multiple logical channels as described herein. For example, one or more devices may include a UE communications manager 101, a base station communications manager 102, or any combination thereof, which may be examples of communications managers as described herein with reference to FIGS. 5-8. The UE 115 and the base station 105 may perform, via the communications managers, a resource allocation procedure and associated communications. For example, the UE 115 may transmit, via the communications manager 101, a buffer status report (BSR), which may indicate an amount of uplink data is present at the UE 115 for uplink transmission, which may include data associated with multiple logical channels. The base station 105 may transmit, via the communications manager 102, an uplink grant to the UE 115, that indicates a set of uplink resources that the UE 115 can use for uplink communications. The UE 115, based on configured LCIDs and associated priorities, and corresponding configured PBRs, may distribute the uplink resources among the multiple LCIDs in accordance with techniques as discussed herein.

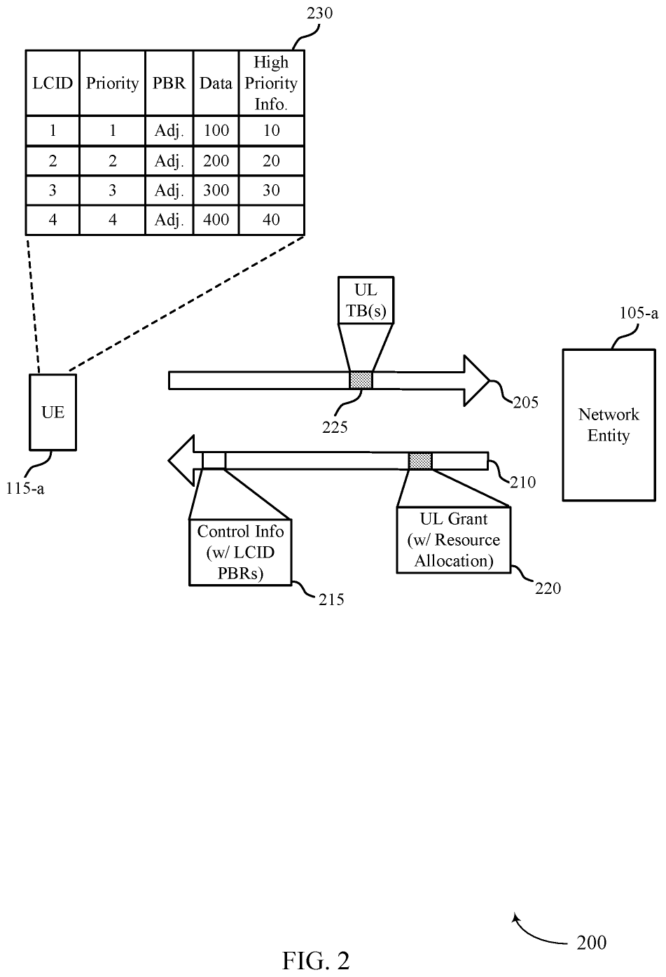

FIG. 2 illustrates an example of a wireless communications system 200 that supports control information prioritization techniques for multiple logical channels in accordance with aspects of the present disclosure. For example, the wireless communications system 200 may include a network entity 105-a and a UE 115-a, which may be examples of a base station 105 and a UE 115 as described herein. Additionally or alternatively, the UE 115-a and the network entity 105-a may be examples of IAB nodes, CPEs, or other devices described herein. The UE 115-a may transmit uplink communications 205 to the network entity 105-a, and the network entity 105-a may transmit downlink communications 210 to the UE 115-a.

In some examples, the network entity 105-a may transmit control signaling 215 to the UE 115-a. In some cases, the control signaling 215 may indicate one or more LCIDs that are configured at the UE 115-a, where each LCID may have an associated priority and PBR, such as illustrated in table 230. In accordance with various techniques as discussed herein, the UE 115-a may adjust one or more PBRs of one or more LCIDs in order to provide sufficient transmissions on each LCID to avoid a window stall. The network entity 105-a, in this example, may transmit an uplink grant 220 to the UE 115-a, that includes an uplink resource allocation for the UE 115-a. The UE 115-a may distribute the uplink resource allocation across the configured LCIDs, and may transmit uplink TBs 225 to the network entity 105-a. In some cases, the UE 115-a may perform adjustments to PBRs without any signaling or indications to the network entity 105-a. In other cases, the control signaling 215 may enable PBR adjustments to be made at the UE 115-a.

As discussed herein, in cases where multiple logical channels are configured, the network entity 105-a may configure each LCID with a PBR. The PBR may indicate a number of bits of data for the associated LCID that are to be distributed in a resource allocation before moving on to a next LCID, which may be infinity (e.g., that indicates that all of the buffered data of the LCID may be allocated up to the amount of allocated uplink resources). Multiple LCIDs may be ordered based on an associated priority. If resources from an uplink allocation still remain after allocations for each LCID, the UE 115-a will repeat the process until either the uplink resource allocation is completely consumed or none of the LCIDs have any more data in their associated buffers.

For example, as illustrated in table 230, the UE 115-a may be configured with four LCIDs with corresponding LCID priorities 1 through 4. In this example, LCID1 has a data buffer of 100 bytes, and has 10 bytes of high priority data (e.g., 10 bytes of RLC control PDU data). Further, LCID2 has a data buffer of 100 bytes and a high priority buffer of 20 bytes, LCID3 has a data buffer of 300 bytes and a high priority buffer of 30 bytes, and LCID4 has a data buffer of 400 bytes and a high priority buffer of 40 bytes. If the UE 115-a were to keep a static PBR and in the event that the PBR of each LCID is set to infinity, an uplink grant that allocates 660 bytes of resources or less will result in at least one of the LCIDs not being able to transmit any data. For example, if the UE 115-a gets 200 bytes of grant from the network entity 105-a, based on the configured PBRs and current pending data, LCID1 would get 110 bytes, LCID2 would get 90 bytes, and LCID3 and LCID4 would each get zero bytes. If such a pattern continued for some time, the network entity 105-a may detect it as a window stall for LCID3 and LCID4, and may release the associated connections based on a timer.

In accordance with various techniques described herein, the UE 115-a may adjust a distribution scheme for uplink resources to efficiently allocate the grant and ensure that lower priority LCIDs get some portion of an uplink grant (e.g., such that prioritized data such as RLC control PDUs or other priority data can be transmitted), and the network entity 105-a will receive data (e.g., prioritized data) for lower priority LCIDs and will not release the associated connections. In some cases, if a lower priority LCID has a RLC control PDU or any higher priority data in general (e.g., data other than new transmission data that is indicated by a toggled new data indicator (NDI)) to transmit, then it will update higher priority LCID PBR to accommodate transmission of at least some data on the lower priority LCID. For example, for each higher priority LCID, the PBR may be adjusted according to:

New PBR=MIN(current PBR, current prioritized data pending buffer).

Continuing with the above example from table 230, the PBR for LCID1 may be adjusted to be 10, the PBR for LCID2 may be adjusted to be 20, the PBR for LCID3may be adjusted to be 30, and the PBR for LCID4 may be adjusted to be 40. With the adjusted PBRs and same 200 bytes of uplink resources, be distribution of the grant to each LCID would be as follows:
1. LCID 1: 110 bytes (10 for RLC control PDU+100 for New TX);
2. LCID 2: 20 bytes (20 for RLC control PDU);
3. LCID 3: 30 bytes (30 for RLC control PDU);
4. LCID 4: 40 bytes (40 for RLC control PDU).
   Thus, in this example, LCID4 and LCID5 are served for higher priority data (e.g., for RLC control PDUs). Such techniques may help to prioritize RLC control PDUs or other priority data such that data stalls are reduced or eliminated, and the network entity 105-a sees the RLC transmit window moving and hence maintains the associated connection. After TB forming for the higher priority data, the UE 115-a may revert the PBR values back to the configured value received from the network entity 105-a, and any remaining uplink resources may be distributed accordingly. Such techniques may thus distribute resources to lower priority LCIDs too to ensure that RLC control PDU or any higher priority data is transmitted in time, following the order of LCID priority, which may prevent window stalling of lower priority LCIDs. Further, sub-optimal PBR configurations by the network entity 105-a may be addressed dynamically as needed by the UE 115-a.

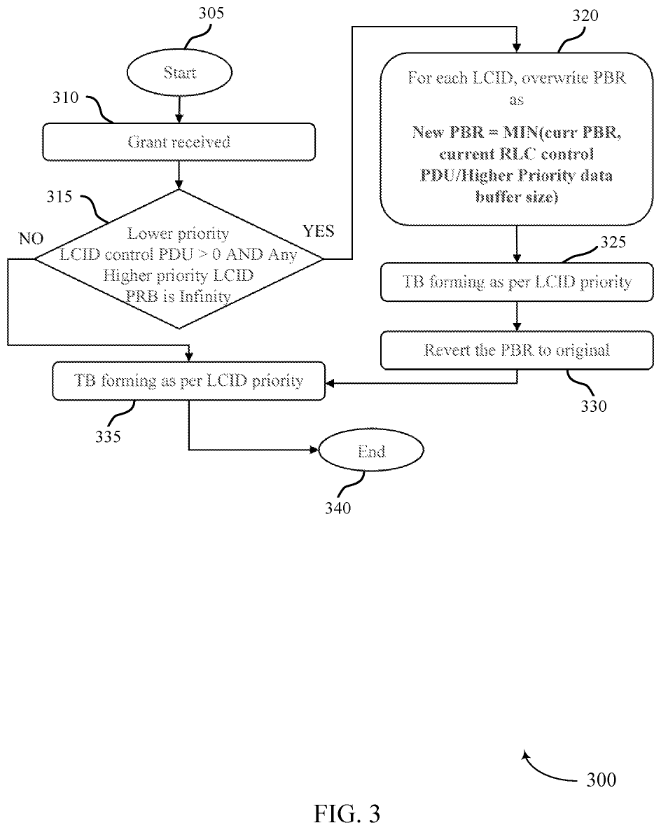

FIG. 3 illustrates an example of a flowchart 300 that supports control information prioritization techniques for multiple logical channels in accordance with aspects of the present disclosure. The operations of the flowchart 300 may be implemented by a UE or its components as described herein. For example, the operations may be performed by a UE 115 as described with reference to FIGS. 1 and 2. In some examples, a UE may execute a set of instructions to control the functional elements of the UE to perform the described functions. Additionally or alternatively, the UE may perform aspects of the described functions using special-purpose hardware.

In this example, operations may start at 305. At 310, the UE may receive an uplink grant. In some cases, the uplink grant may be received from a network entity, and may include an allocation of a set of uplink resources. At 315, the UE may determine whether any lower priority LCID has a control PDU (or other higher priority data) to be transmitted, and whether any higher priority LCID has a PBR set to infinity.

If the determination at 315 is yes, at 320 the UE may adjust one or more PBRs in accordance with techniques discussed herein. For example, the UE may, for each LCID, overwrite the PBR as New PBR=MIN(current PBR, current RLC control PDU/higher priority data buffer size). At 325, the UE may form TBs according to the LCID priority based on the adjusted PBRs. At 330, the UE may revert the PBRs back to the original values. At 335, the UE may perform TB forming per the LCID priority according to the original PBRs, subsequent to the operations at 330 or to a ‘NO’ determination at 315. The operations may end at 340.

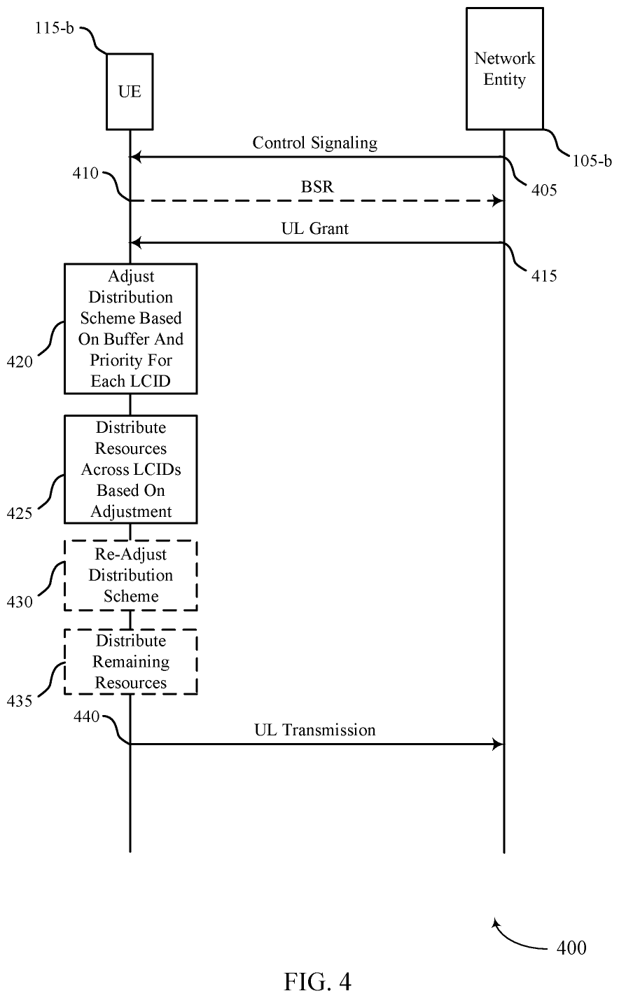

FIG. 4 illustrates an example of a process flow 400 that supports control information prioritization techniques for multiple logical channels in accordance with aspects of the present disclosure. The process flow 400 may implement aspects of the wireless communications system 100 and the wireless communications system 200 described with reference to FIGS. 1 and 2, respectively.

In the following description of the process flow 400, the operations between a network entity 105-b and a UE 115-b may be transmitted in a different order than the example order shown, or the operations performed by the network entity 105-b and the UE 115b may be performed in different orders or at different times. Some operations may also be omitted from the process flow 400, and other operations may be added to the process flow 400. The network entity 105-b and the UE 115-b may be examples of a network entity 105 and UE 115 as described with reference to FIGS. 1 and 2, respectively.

The UE 115-b may establish a communication link with the network entity 105-b in accordance with connection establishment techniques (e.g., RRC connection establishment techniques). At 405, the network entity 105-b may transmit control signaling to the UE 115-b. The control signaling may include, for example, configuration information for a number of logical channels, which may include an associated priority and PBR for each LCID. In some examples, the network entity 105-b may transmit the control signaling in system information, radio resource control (RRC) signaling, in a MAC-CE, in downlink control information, or the like.

Optionally, at 410, the UE 115-b may transmit a buffer status report (BSR). The BSR may indicate an amount of uplink data that is to be transmitted from the UE 115-b on one or more logical channels. At 415, the network entity 105-b may transmit an uplink grant to the UE 115-b. The uplink grant may include an uplink resource allocation for a set of uplink resources, for example.

At 420, the UE 115-b may adjust a distribution scheme based on the buffer of each LCID and a priority associated with each LCID. The adjustment may include adjusting the PBR associated with one or more LCIDs, in accordance with techniques as discussed herein. At 425, the UE 115-b may distribute resources across LCIDs based on the adjustment. Optionally, at 430, the UE 115-b may re-adjust the PBRs and distribution scheme, and at 435 the UE 115-b may distribute any remaining resources from the set of uplink resources allocated in the uplink grant. At 440, the UE 115-b may transmit the uplink transmission to the network entity 105-b, including higher priority data for one or more lower priority LCIDs.

FIG. 5 shows a block diagram 500 of a device 505 that supports control information prioritization techniques for multiple logical channels in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to control information prioritization techniques for multiple logical channels). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to control information prioritization techniques for multiple logical channels). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of control information prioritization techniques for multiple logical channels as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for receiving an uplink grant that indicates a resource allocation for an uplink communication from the UE to a network entity, the resource allocation for distribution among at least two logical channels including a first logical channel that has a higher priority than a second logical channel, where a distribution scheme provides a first amount of the resource allocation to the first logical channel and the first amount exceeds a threshold value. The communications manager 520 may be configured as or otherwise support a means for adjusting the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel. The communications manager 520 may be configured as or otherwise support a means for transmitting one or more transport blocks that include the first amount of control information for the first logical channel and the second amount of control information for the second logical channel.

By including or configuring the communications manager 520 in accordance with examples as described herein, the device 505 (e.g., a processor controlling or otherwise coupled to the receiver 510, the transmitter 515, the communications manager 520, or a combination thereof) may support adjustment of resource distribution techniques to provide lower priority logical channels with sufficient resources to prevent a window stall as described herein, which may result in decreased system latency, and reduced overhead associated with fewer releases of logical channels, and corresponding reductions in power usage.

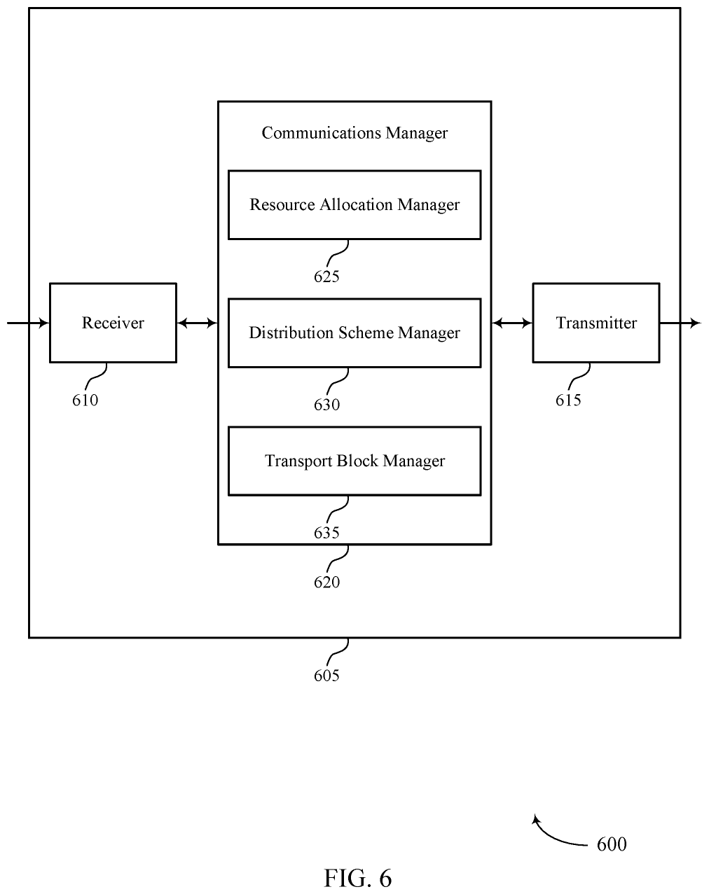

FIG. 6 shows a block diagram 600 of a device 605 that supports control information prioritization techniques for multiple logical channels in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to control information prioritization techniques for multiple logical channels). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to control information prioritization techniques for multiple logical channels). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of control information prioritization techniques for multiple logical channels as described herein. For example, the communications manager 620 may include a resource allocation manager 625, a distribution scheme manager 630, a transport block manager 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The resource allocation manager 625 may be configured as or otherwise support a means for receiving an uplink grant that indicates a resource allocation for an uplink communication from the UE to a network entity, the resource allocation for distribution among at least two logical channels including a first logical channel that has a higher priority than a second logical channel, where a distribution scheme provides a first amount of the resource allocation to the first logical channel and the first amount exceeds a threshold value. The distribution scheme manager 630 may be configured as or otherwise support a means for adjusting the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel. The transport block manager 635 may be configured as or otherwise support a means for transmitting one or more transport blocks that include the first amount of control information for the first logical channel and the second amount of control information for the second logical channel.

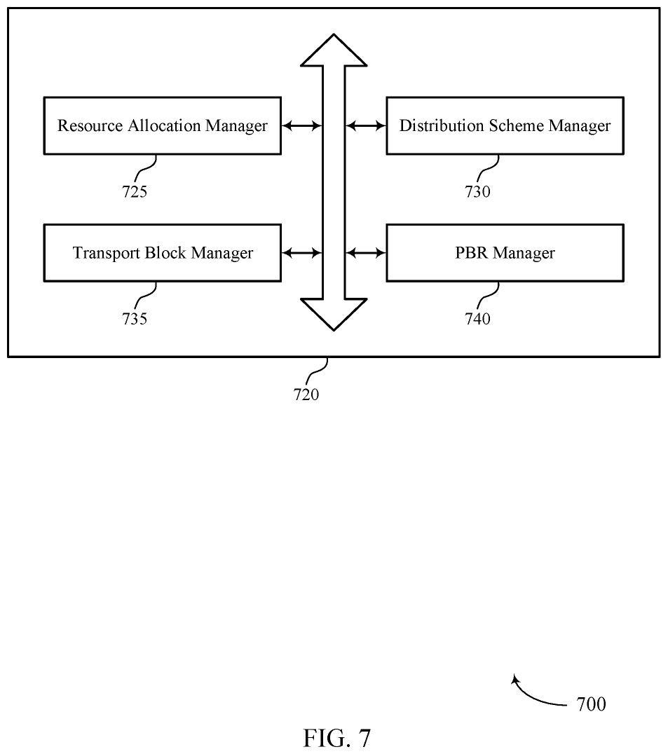

FIG. 7 shows a block diagram 700 of a communications manager 720 that supports control information prioritization techniques for multiple logical channels in accordance with aspects of the present disclosure. The communications manager 720 may be an example of aspects of a communications manager 520, a communications manager 620, or both, as described herein. The communications manager 720, or various components thereof, may be an example of means for performing various aspects of control information prioritization techniques for multiple logical channels as described herein. For example, the communications manager 720 may include a resource allocation manager 725, a distribution scheme manager 730, a transport block manager 735, a PBR manager 740, or any combination thereof. Each of these components may communicate, directly or indirectly, with one another (e.g., via one or more buses).

The communications manager 720 may support wireless communication at a UE in accordance with examples as disclosed herein. The resource allocation manager 725 may be configured as or otherwise support a means for receiving an uplink grant that indicates a resource allocation for an uplink communication from the UE to a network entity, the resource allocation for distribution among at least two logical channels including a first logical channel that has a higher priority than a second logical channel, where a distribution scheme provides a first amount of the resource allocation to the first logical channel and the first amount exceeds a threshold value. The distribution scheme manager 730 may be configured as or otherwise support a means for adjusting the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel. The transport block manager 735 may be configured as or otherwise support a means for transmitting one or more transport blocks that include the first amount of control information for the first logical channel and the second amount of control information for the second logical channel.

In some examples, the distribution scheme manager 730 may be configured as or otherwise support a means for re-adjusting the distribution scheme to provide a remaining portion of the first amount of the resource allocation to the first logical channel. In some examples, the transport block manager 735 may be configured as or otherwise support a means for where the one or more transport blocks include additional uplink data for at least the first logical channel based on the remaining portion of the first amount of the resource allocation.

In some examples, to support adjusting, the PBR manager 740 may be configured as or otherwise support a means for updating a first prioritized bit rate (PBR) of the first logical channel to correspond to the first amount of control information. In some examples, to support adjusting, the PBR manager 740 may be configured as or otherwise support a means for updating a second PBR of the second logical channel to correspond to the second amount of control information.

In some examples, the first amount of control information and the second amount of control information occupy a first subset of the resource allocation, and the distribution scheme manager 730 may be configured as or otherwise support a means for distributing a second subset of the resource allocation among the at least two logical channels based on an original prioritized bit rate associated with each logical channel of the at least two logical channels.

In some examples, to support adjusting, the PBR manager 740 may be configured as or otherwise support a means for adjusting, for each logical channel of the at least two logical channels, a PBR to correspond to a minimum of a current PBR or a corresponding amount of control information that is to be transmitted on the associated logical channel. In some examples, the first amount of control information corresponds to a first number of bytes in a first high priority traffic PDU of the first logical channel, and the second amount of control information corresponds to a second number of bytes in a second high priority traffic PDU of the second logical channel. In some examples, a highest priority logical channel of the two or more logical channels is provided with any remaining resources of the resource allocation prior to distributing any resources of the resource allocation to any lower priority logical channels.

In some examples, the distribution scheme manager 730 may be configured as or otherwise support a means for forming the one or more transport blocks in accordance with the distribution scheme for transmission to the network entity. In some examples, the adjusting is performed based on whether the second logical channel has an RLC control PDU or high priority data in an associated transmit buffer. In some examples, the adjusting is performed based on whether the first logical channel has a PBR that is set to infinity.

In some examples, the adjustment to the distribution scheme prevents a bearer release of the second logical channel by providing resources for at least the second amount of control information for the second logical channel.

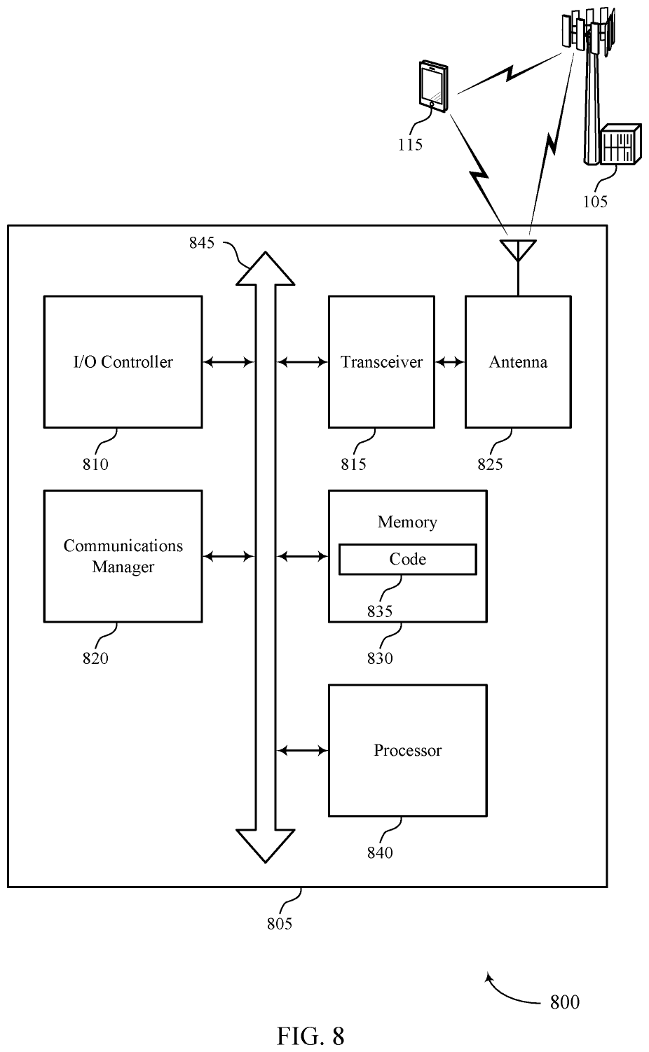

FIG. 8 shows a diagram of a system 800 including a device 805 that supports control information prioritization techniques for multiple logical channels in accordance with aspects of the present disclosure. The device 805 may be an example of or include the components of a device 505, a device 605, or a UE 115 as described herein. The device 805 may communicate wirelessly with one or more base stations 105 (or other network entities), UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting control information prioritization techniques for multiple logical channels). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving an uplink grant that indicates a resource allocation for an uplink communication from the UE to a network entity, the resource allocation for distribution among at least two logical channels including a first logical channel that has a higher priority than a second logical channel, where a distribution scheme provides a first amount of the resource allocation to the first logical channel and the first amount exceeds a threshold value. The communications manager 820 may be configured as or otherwise support a means for adjusting the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel. The communications manager 820 may be configured as or otherwise support a means for transmitting one or more transport blocks that include the first amount of control information for the first logical channel and the second amount of control information for the second logical channel.

By including or configuring the communications manager 820 in accordance with examples as described herein, the device 805 may support adjustment of resource distribution techniques to provide lower priority logical channels with sufficient resources to prevent a window stall as described herein, which may result in decreased system latency, and reduced overhead associated with fewer releases of logical channels, and corresponding reductions in power usage.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of control information prioritization techniques for multiple logical channels as described herein, or the processor 840 and the memory 830 may be otherwise configured to perform or support such operations.

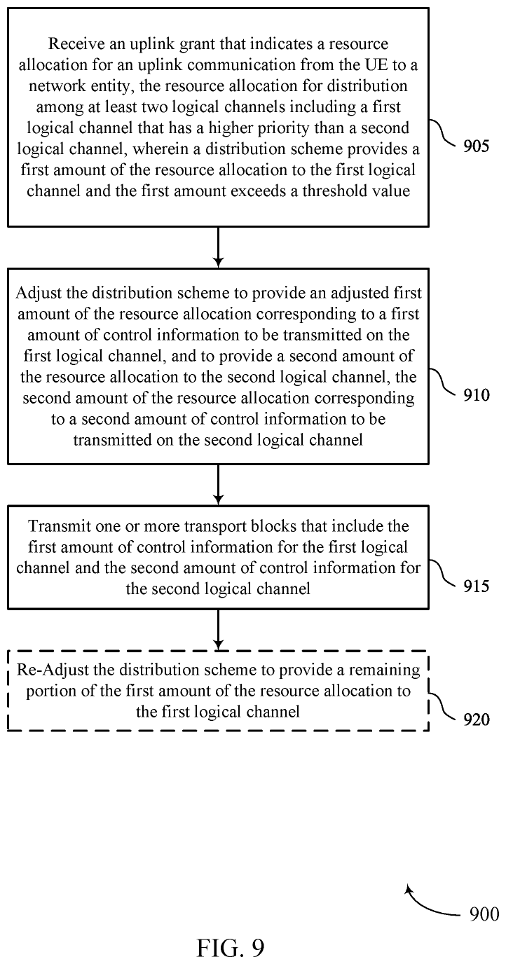

FIG. 9 shows a flowchart illustrating a method 900 that supports control information prioritization techniques for multiple logical channels in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include receiving an uplink grant that indicates a resource allocation for an uplink communication from the UE to a network entity, the resource allocation for distribution among at least two logical channels including a first logical channel that has a higher priority than a second logical channel, where a distribution scheme provides a first amount of the resource allocation to the first logical channel and the first amount exceeds a threshold value. The operations of 905 may be performed in accordance with examples as disclosed herein. In some examples, aspects of the operations of 905 may be performed by a resource allocation manager 725 as described with reference to FIG. 7.

At 910, the method may include adjusting the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel. The operations of 910 may be performed in accordance with examples as disclosed herein. In some examples, aspects of the operations of 910 may be performed by a distribution scheme manager 730 as described with reference to FIG. 7.

At 915, the method may include transmitting one or more transport blocks that include the first amount of control information for the first logical channel and the second amount of control information for the second logical channel. The operations of 915 may be performed in accordance with examples as disclosed herein. In some examples, aspects of the operations of 915 may be performed by a transport block manager 735 as described with reference to FIG. 7.

Optionally, at 920, the method may include re-adjusting the distribution scheme to provide a remaining portion of the first amount of the resource allocation to the first logical channel. The operations of 920 may be performed in accordance with examples as disclosed herein. In some examples, aspects of the operations of 920 may be performed by a distribution scheme manager 730 as described with reference to FIG. 7. In some cases, the one or more transport blocks include additional uplink data for at least the first logical channel based on the remaining portion of the first amount of the resource allocation.

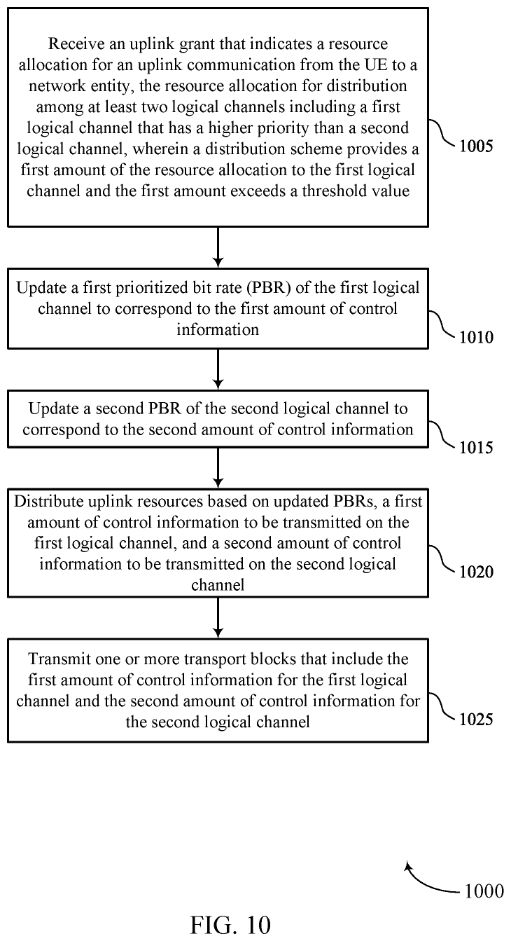

FIG. 10 shows a flowchart illustrating a method 1000 that supports control information prioritization techniques for multiple logical channels in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include receiving an uplink grant that indicates a resource allocation for an uplink communication from the UE to a network entity, the resource allocation for distribution among at least two logical channels including a first logical channel that has a higher priority than a second logical channel, where a distribution scheme provides a first amount of the resource allocation to the first logical channel and the first amount exceeds a threshold value. The operations of 1005 may be performed in accordance with examples as disclosed herein. In some examples, aspects of the operations of 1005 may be performed by a resource allocation manager 725 as described with reference to FIG. 7.

At 1010, the method may include updating a first prioritized bit rate (PBR) of the first logical channel to correspond to the first amount of control information. The operations of 1010 may be performed in accordance with examples as disclosed herein. In some examples, aspects of the operations of 1010 may be performed by a PBR manager 740 as described with reference to FIG. 7.

At 1015, the method may include updating a second PBR of the second logical channel to correspond to the second amount of control information. The operations of 1015 may be performed in accordance with examples as disclosed herein. In some examples, aspects of the operations of 1015 may be performed by a PBR manager 740 as described with reference to FIG. 7.

At 1020, the method may include distributing uplink resources based on updated PBRs, a first amount of control information to be transmitted on the first logical channel, and a second amount of control information to be transmitted on the second logical channel. The operations of 1020 may be performed in accordance with examples as disclosed herein. In some examples, aspects of the operations of 1020 may be performed by a distribution scheme manager 730 as described with reference to FIG. 7.

At 1025, the method may include transmitting one or more transport blocks that include the first amount of control information for the first logical channel and the second amount of control information for the second logical channel. The operations of 1025 may be performed in accordance with examples as disclosed herein. In some examples, aspects of the operations of 1025 may be performed by a transport block manager 735 as described with reference to FIG. 7.

The following provides an overview of aspects of the present disclosure:

Aspect 1: A method for wireless communication at a UE, comprising: receiving an uplink grant that indicates a resource allocation for an uplink communication from the UE to a network entity, the resource allocation for distribution among at least two logical channels including a first logical channel that has a higher priority than a second logical channel, wherein a distribution scheme provides a first amount of the resource allocation to the first logical channel and the first amount exceeds a threshold value; adjusting the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel; and transmitting one or more transport blocks that include the first amount of control information for the first logical channel and the second amount of control information for the second logical channel.

Aspect 2: The method of aspect 1, further comprising: re-adjusting the distribution scheme to provide a remaining portion of the first amount of the resource allocation to the first logical channel, and wherein the one or more transport blocks include additional uplink data for at least the first logical channel based at least in part on the remaining portion of the first amount of the resource allocation.

Aspect 3: The method of any of aspects 1 through 2, wherein the adjusting comprises: updating a first prioritized bit rate (PBR) of the first logical channel to correspond to the first amount of control information; and updating a second PBR of the second logical channel to correspond to the second amount of control information.

Aspect 4: The method of any of aspects 1 through 3, wherein the first amount of control information and the second amount of control information occupy a first subset of the resource allocation, and wherein the method further comprises: distributing a second subset of the resource allocation among the at least two logical channels based at least in part on an original prioritized bit rate associated with each logical channel of the at least two logical channels.

Aspect 5: The method of any of aspects 1 through 4, wherein the adjusting comprises: adjusting, for each logical channel of the at least two logical channels, a prioritized bit rate (PBR) to correspond to a minimum of a current PBR or a corresponding amount of control information that is to be transmitted on the associated logical channel.

Aspect 6: The method of any of aspects 1 through 5, wherein the first amount of control information corresponds to a first number of bytes in a first high priority traffic protocol data unit (PDU) of the first logical channel, and the second amount of control information corresponds to a second number of bytes in a second high priority traffic PDU of the second logical channel.

Aspect 7: The method of any of aspects 1 through 6, wherein a highest priority logical channel of the two or more logical channels is provided with any remaining resources of the resource allocation prior to distributing any resources of the resource allocation to any lower priority logical channels.

Aspect 8: The method of any of aspects 1 through 7, further comprising: forming the one or more transport blocks in accordance with the distribution scheme for transmission to the network entity.

Aspect 9: The method of any of aspects 1 through 8, wherein the adjusting is performed based at least in part on whether the second logical channel has an RLC control protocol data unit (PDU) or high priority data in an associated transmit buffer.

Aspect 10: The method of any of aspects 1 through 9, wherein the adjusting is performed based at least in part on whether the first logical channel has a prioritized bit rate (PBR) that is set to infinity.

Aspect 11: The method of any of aspects 1 through 10, wherein the adjustment to the distribution scheme prevents a bearer release of the second logical channel by providing resources for at least the second amount of control information for the second logical channel.

Aspect 12: An apparatus for wireless communication at a UE, comprising a processor; memory coupled with the processor; and instructions stored in the memory and executable by the processor to cause the apparatus to perform a method of any of aspects 1 through 11.

Aspect 13: An apparatus for wireless communication at a UE, comprising at least one means for performing a method of any of aspects 1 through 11.

Aspect 14: A non-transitory computer-readable medium storing code for wireless communication at a UE, the code comprising instructions executable by a processor to perform a method of any of aspects 1 through 11.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving an uplink grant that indicates a resource allocation for an uplink communication from the UE to a network entity, the resource allocation for distribution among at least two logical channels including a first logical channel that has a higher priority than a second logical channel, wherein a distribution scheme provides a first amount of the resource allocation to the first logical channel and the first amount exceeds a threshold value;
adjusting the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel; and
transmitting one or more transport blocks that include the first amount of control information for the first logical channel and the second amount of control information for the second logical channel.

2. The method of claim 1, further comprising:
re-adjusting the distribution scheme to provide a remaining portion of the first amount of the resource allocation to the first logical channel, and
wherein the one or more transport blocks include additional uplink data for at least the first logical channel based at least in part on the remaining portion of the first amount of the resource allocation.

3. The method of claim 1, the adjusting comprising:
updating a first prioritized bit rate (PBR) of the first logical channel to correspond to the first amount of control information; and
updating a second PBR of the second logical channel to correspond to the second amount of control information.

4. The method of claim 1, wherein the first amount of control information and the second amount of control information occupy a first subset of the resource allocation, and wherein the method further comprises:
distributing a second subset of the resource allocation among the at least two logical channels based at least in part on an original prioritized bit rate associated with each logical channel of the at least two logical channels.

5. The method of claim 1, the adjusting comprising:
adjusting, for each logical channel of the at least two logical channels, a prioritized bit rate (PBR) to correspond to a minimum of a current PBR or a corresponding amount of control information that is to be transmitted on the associated logical channel.

6. The method of claim 1, wherein the first amount of control information corresponds to a first number of bytes in a first high priority traffic protocol data unit (PDU) of the first logical channel, and the second amount of control information corresponds to a second number of bytes in a second high priority traffic PDU of the second logical channel.

7. The method of claim 1, wherein a highest priority logical channel of the two or more logical channels is provided with any remaining resources of the resource allocation prior to distributing any resources of the resource allocation to any lower priority logical channels.

8. The method of claim 1, further comprising:
forming the one or more transport blocks in accordance with the distribution scheme for transmission to the network entity.

9. The method of claim 1, wherein the adjusting is performed based at least in part on whether the second logical channel has a radio link control (RLC) control protocol data unit (PDU) or high priority data in an associated transmit buffer.

10. The method of claim 1, wherein the adjusting is performed based at least in part on whether the first logical channel has a prioritized bit rate (PBR) that is set to infinity.

11. The method of claim 1, wherein the adjustment to the distribution scheme prevents a bearer release of the second logical channel by providing resources for at least the second amount of control information for the second logical channel.

12. An apparatus for wireless communication at a user equipment (UE), comprising:
a processor; and
memory coupled with the processor, the processor and memory configured to:
receive an uplink grant that indicates a resource allocation for an uplink communication from the UE to a network entity, the resource allocation for distribution among at least two logical channels including a first logical channel that has a higher priority than a second logical channel, wherein a distribution scheme provides a first amount of the resource allocation to the first logical channel and the first amount exceeds a threshold value;
adjust the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel; and
transmit one or more transport blocks that include the first amount of control information for the first logical channel and the second amount of control information for the second logical channel.

13. The apparatus of claim 12, wherein the processor and memory are further configured to:
re-adjust the distribution scheme to provide a remaining portion of the first amount of the resource allocation to the first logical channel, and
wherein the one or more transport blocks include additional uplink data for at least the first logical channel based at least in part on the remaining portion of the first amount of the resource allocation.

14. The apparatus of claim 12, wherein, to adjust the distribution scheme, the processor and memory are configured to:
update a first prioritized bit rate (PBR) of the first logical channel to correspond to the first amount of control information; and
update a second PBR of the second logical channel to correspond to the second amount of control information.

15. The apparatus of claim 12, wherein the first amount of control information and the second amount of control information occupy a first subset of the resource allocation, and the processor and memory are further configured to:
distribute a second subset of the resource allocation among the at least two logical channels based at least in part on an original prioritized bit rate associated with each logical channel of the at least two logical channels.

16. The apparatus of claim 12, wherein, to adjust the distribution scheme, the processor and memory are configured to:
adjust, for each logical channel of the at least two logical channels, a prioritized bit rate (PBR) to correspond to a minimum of a current PBR or a corresponding amount of control information that is to be transmitted on the associated logical channel.

17. The apparatus of claim 12, wherein the first amount of control information corresponds to a first number of bytes in a first high priority traffic protocol data unit (PDU) of the first logical channel, and the second amount of control information corresponds to a second number of bytes in a second high priority traffic PDU of the second logical channel.

18. The apparatus of claim 12, wherein a highest priority logical channel of the two or more logical channels is provided with any remaining resources of the resource allocation prior to distributing any resources of the resource allocation to any lower priority logical channels.

19. The apparatus of claim 12, wherein the processor and memory are further configured to:
form the one or more transport blocks in accordance with the distribution scheme for transmission to the network entity.

20. The apparatus of claim 12, wherein the adjustment to the distribution scheme is performed based at least in part on whether the second logical channel has a radio link control (RLC) control protocol data unit (PDU) or high priority data in an associated transmit buffer.

21. The apparatus of claim 12, wherein the adjustment to the distribution scheme is performed based at least in part on whether the first logical channel has a prioritized bit rate (PBR) that is set to infinity.

22. The apparatus of claim 12, wherein the adjustment to the distribution scheme prevents a bearer release of the second logical channel by providing resources for at least the second amount of control information for the second logical channel.

23. An apparatus for wireless communication at a user equipment (UE), comprising:
means for receiving an uplink grant that indicates a resource allocation for an uplink communication from the UE to a network entity, the resource allocation for distribution among at least two logical channels including a first logical channel that has a higher priority than a second logical channel, wherein a distribution scheme provides a first amount of the resource allocation to the first logical channel and the first amount exceeds a threshold value;
means for adjusting the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel; and
means for transmitting one or more transport blocks that include the first amount of control information for the first logical channel and the second amount of control information for the second logical channel.

24. The apparatus of claim 23, further comprising:
means for re-adjusting the distribution scheme to provide a remaining portion of the first amount of the resource allocation to the first logical channel, and
means for wherein the one or more transport blocks include additional uplink data for at least the first logical channel based at least in part on the remaining portion of the first amount of the resource allocation.

25. The apparatus of claim 23, wherein the means for the adjusting comprise:
means for updating a first prioritized bit rate (PBR) of the first logical channel to correspond to the first amount of control information; and
means for updating a second PBR of the second logical channel to correspond to the second amount of control information.

26. The apparatus of claim 23, wherein the first amount of control information and the second amount of control information occupy a first subset of the resource allocation, the apparatus further comprising:
means for distributing a second subset of the resource allocation among the at least two logical channels based at least in part on an original prioritized bit rate associated with each logical channel of the at least two logical channels.

27. A non-transitory computer-readable medium storing code for wireless communication at a user equipment (UE), the code comprising instructions executable by a processor to:
receive an uplink grant that indicates a resource allocation for an uplink communication from the UE to a network entity, the resource allocation for distribution among at least two logical channels including a first logical channel that has a higher priority than a second logical channel, wherein a distribution scheme provides a first amount of the resource allocation to the first logical channel and the first amount exceeds a threshold value;
adjust the distribution scheme to provide an adjusted first amount of the resource allocation corresponding to a first amount of control information to be transmitted on the first logical channel, and to provide a second amount of the resource allocation to the second logical channel, the second amount of the resource allocation corresponding to a second amount of control information to be transmitted on the second logical channel; and
transmit one or more transport blocks that include the first amount of control information for the first logical channel and the second amount of control information for the second logical channel.

28. The non-transitory computer-readable medium of claim 27, wherein the instructions are further executable by the processor to:
re-adjust the distribution scheme to provide a remaining portion of the first amount of the resource allocation to the first logical channel, and
wherein the one or more transport blocks include additional uplink data for at least the first logical channel based at least in part on the remaining portion of the first amount of the resource allocation.

29. The non-transitory computer-readable medium of claim 27, wherein the instructions to adjusting are executable by the processor to:
update a first prioritized bit rate (PBR) of the first logical channel to correspond to the first amount of control information; and
update a second PBR of the second logical channel to correspond to the second amount of control information.

30. The non-transitory computer-readable medium of claim 27, wherein the instructions to adjusting are executable by the processor to:
adjust, for each logical channel of the at least two logical channels, a prioritized bit rate (PBR) to correspond to a minimum of a current PBR or a corresponding amount of control information that is to be transmitted on the associated logical channel.
